(19) United States
(12) Patent Application Publication
(10) Pub. No.: US 2023/0072469 A1
(43) Pub. Date: Mar. 9, 2023

(54) SURFACE COATING COMPOSITIONS

(71) Applicant: ARMSTRONG WORLD INDUSTRIES, INC., Lancaster, PA (US)

(72) Inventors: John E. HUGHES, Lincoln University, PA (US); Linzhu ZHANG, Ephrata, PA (US); Michelle X. WANG, Lititz, PA (US)

(21) Appl. No.: 17/939,444

(22) Filed: Sep. 7, 2022

Related U.S. Application Data
(60) Provisional application No. 63/242,307, filed on Sep. 9, 2021.

(51) Int. Cl. C09D 1/04; C09D 7/61; C09D 7/65; C09D 5/18

(52) U.S. Cl. CPC C09D 1/04; C09D 5/18; C09D 7/61; C09D 7/65

(57) ABSTRACT

Described herein is a surface coating composition useful to provide durability and fire resistance to building panels, as well as methods to prepare the same. The coating composition comprises silicate present in an amount from about 65 to about 85 wet wt. %; hectorite clay present in an amount from about 0.15 to about 0.5 wet wt. %; silica present in an amount from about 1 to about 3 wet wt. %; and polysorbate present in an amount from about 0.5 to about 10 wet wt. %.

### CROSS REFERENCE TO RELATED APPLICATIONS

This application claims the benefit of U.S. Provisional Application No. 63/242,307, filed on Sep. 9, 2021. The disclosure of the above application(s) is (are) incorporated herein by reference.

### FIELD OF THE DISCLOSURE

The present disclosure relates to a surface coating composition useful for coating substrates, such as building materials. The inventive composition exhibits stable and anti-cracking attributes and provides for superior fire resistant qualities.

### BACKGROUND

Surface coating compositions are applied on substrates for a variety of reasons, including to enhance substrate durability and finish. While conventional coatings provide certain protection to the substrate, these coatings are also prone to damage, such as cracking, due to heat exposure and humidity from the surroundings. Furthermore, many building panels are made of cellulose, such as wood. Wood is known to contract and expand depending on the temperature and humidity of the surrounding environment, thus further damaging the coating material.

Therefore, it would be desirable to have a coating which exhibits improved resistance to the environment.

However, in addition to providing durability, surface coatings must also provide for functional aspects. For example, surface coatings having superior fire resistant qualities would be beneficial.

Thus, there is a need for improved coating compositions which provide robust durability, usability, and superior fire resistive properties. Embodiments of the present invention are directed to meeting these needs.

### SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

Applicants have discovered coating compositions useful for use as a building panel surface coating for both indoor and outdoor applications. Such coating compositions provide for stable and durable protection of the substrate. Such coating compositions also provide for beneficial fire preventive and resistive characteristics.

Thus, in certain embodiments, the present invention provides a building panel comprising a first major surface opposite a second major surface and a side surface extending there-between, the building panel further comprising a coating comprising silicate present in an amount from about 65 to about 85 wet wt. %; hectorite clay present in an amount from about 0.15 to about 0.5 wet wt. %; silica present in an amount from about 1 to about 3 wet wt. %; and polysorbate present in an amount from about 0.5 to about 10 wet wt. %. In certain embodiments, the silicate comprises an alkali metal. In certain embodiments, the alkali metal is selected from sodium or potassium. In certain embodiments, the silicate is present in an amount from about 70 to about 80 wet wt. %. In certain embodiments, the hectorite clay is present in an amount from about 0.2 to about 0.4 wet wt. %. In certain embodiments, the wet weight ratio of the silicate to the hectorite clay is from about 217:1 to about 567:1. In certain embodiments, the silica is selected from silica dust, fumed silica, finely divided silica, and mixtures thereof. In certain embodiments, the silica is fumed silica. In certain embodiments, the polysorbate is selected from the group consisting of polysorbate 20, polysorbate 40, polysorbate 60, polysorbate 80, and mixtures thereof. In certain embodiments, the polysorbate is present in an amount from about 0.5 to about 5.0 wet wt. %. In certain embodiments, the coating further comprises Al(OH)₃. In certain embodiments, the Al(OH)₃ is present in an amount from about 0.5 to about 3.5 wet wt. %. In certain embodiments, the coating further comprises EO/PO alcohol. In certain embodiments, the EO/PO alcohol is non-ionic. In certain embodiments, the EO/PO alcohol is present in an amount from about 0.1 to about 1.5 wet wt. %. In certain embodiments, the coating further comprises pigment. In certain embodiments, the pigment is present in an amount from about 0.01 to about 0.5 wet wt. %. In certain embodiments, the coating further comprises a polyether-siloxane copolymer emulsion. In certain embodiments, the polyether-siloxane copolymer emulsion is present in an amount from about 0.01 to about 0.1 wet wt. %. In certain embodiments, the coating further comprises a sodium polyacrylate ionic surfactant. In certain embodiments, the sodium polyacrylate ionic surfactant is present in an amount from about 0.005 to about 0.075 wet wt. %. In certain embodiments, the wet weight ratio of the EO/PO alcohol to the sodium polyacrylate ionic surfactant is from about 1:1 to about 300:1. In certain embodiments, the wet weight ratio of the EO/PO alcohol to the sodium polyacrylate ionic surfactant is from about 40:1 to about 60:1. In certain embodiments, the building panel is a wall or ceiling panel.

In certain embodiments, the present invention is a coating composition comprising silicate present in an amount from about 65 to about 85 wet wt. %; hectorite clay present in an amount from about 0.15 to about 0.5 wet wt. %; silica present in an amount from about 1 to about 3 wet wt. %; and polysorbate present in an amount from about 0.5 to about 10 wet wt. %. In certain embodiments, the silicate comprises an alkali metal. In certain embodiments, the alkali metal is selected from sodium or potassium. In certain embodiments, the silicate is present in an amount from about 70 to about 80 wet wt. %. In certain embodiments, the hectorite clay is present in an amount from about 0.2 to about 0.4 wet wt. %. In certain embodiments, the wet weight ratio of the silicate to the hectorite clay is from about 217:1 to about 567:1. In certain embodiments, the silica is selected from silica dust, fumed silica, finely divided silica, and mixtures thereof. In certain embodiments, the silica is fumed silica. In certain embodiments, the polysorbate is selected from the group consisting of polysorbate 20, polysorbate 40, polysorbate 60, polysorbate 80, and mixtures thereof. In certain embodiments, the polysorbate is present in an amount from about 0.5 to about 5.0 wet wt. %. In certain embodiments, the coating further comprises Al(OH)₃. In certain embodiments, the Al(OH)₃ is present in an amount from about 0.5 to about 3.5 wet wt. %. In certain embodiments, the coating further comprises EO/PO alcohol. In certain embodiments, the EO/PO alcohol is non-ionic. In certain embodiments, the EO/PO alcohol is present in an amount from about 0.1 to about 1.5 wet wt. %. In certain embodiments, the coating further comprises pigment. In certain embodiments, the pigment is present in an amount from about 0.01 to about 0.5 wet wt. %. In certain embodiments, the coating further comprises a polyether-siloxane copolymer emulsion. In certain embodiments, the polyether-siloxane copolymer emulsion is present in an amount from about 0.01 to about 0.1 wet wt. %. In certain embodiments, the coating further comprises a sodium polyacrylate ionic surfactant. In certain embodiments, the sodium polyacrylate ionic surfactant is present in an amount from about 0.005 to about 0.1 wet wt. %. In certain embodiments, the wet weight ratio of the EO/PO alcohol to the sodium polyacrylate ionic surfactant is from about 1:1 to about 300:1. In certain embodiments, the wet weight ratio of the EO/PO alcohol to the sodium polyacrylate ionic surfactant is from about 40:1 to about 60:1.

In other embodiments, the invention is a method for protecting a building panel, comprising coating the building panel with a coating composition as described in any of the embodiments disclosed herein. In certain embodiments, the building panel is a wall or ceiling panel. In certain embodiments, the building panel comprises cellulose.

In other embodiments, the invention is a method for improving fire resistance of a building panel, comprising coating the building panel with a coating composition as described in any of the embodiments disclosed herein. In certain embodiments, the building panel is a wall or ceiling panel. In certain embodiments, the building panel comprises cellulose.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### DESCRIPTION OF THE DRAWINGS

The detailed description of the invention will be better understood when read in conjunction with the appended drawings. It should be understood, however, that the invention is not limited to the precise arrangements and instrumentalities of the embodiments shown in the drawings.

FIG. 1 is a top perspective view of a building panel according to one embodiment of the invention; and

FIG. 2 is a cross-sectional view of a building according to an embodiment of the present invention, the cross sectional being along the II line set forth in FIG. 1.

All drawings are schematic and not necessarily to scale. Parts given a reference numerical designation in one figure may be considered to be the same parts where they appear in other figures without a numerical designation for brevity unless specifically labeled with a different part number and described herein.

### DETAILED DESCRIPTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other applications and methods. It is to be understood that the invention is not limited in its application to the details of any particular embodiment shown. The terminology used herein is for the purpose of description and not to limit the invention, its application, or uses.

As used herein and in the appended claims, the singular forms “a”, “an”, and “the” include plural references unless the context dictates otherwise. The singular form of any class of the ingredients refers not only to one chemical species within that class, but also to a mixture of those chemical species. The terms “a” (or “an”), “one or more” and “at least one” may be used interchangeably herein. The terms “comprising”, “including”, “containing”, and “having” may be used interchangeably. The term “include” should be interpreted as “include, but are not limited to”. The term “including” should be interpreted as “including, but are not limited to”.

As used throughout, ranges are used as shorthand for describing each and every value that is within the range. Any value within the range can be selected as the terminus of the range.

Unless otherwise specified, all percentages and amounts expressed herein and elsewhere in the specification should be understood to refer to percentages by weight of the total composition. Unless otherwise specified, reference to a molecule, or to molecules, being present at a “wt.%” refers to the amount of that molecule, or molecules, present in the composition based on the total weight of the composition. As used herein, the term “wet wt.%” refers to the amount of that molecule, or molecules, present in the composition based on the total weight of the composition as a liquid.

According to the present application, use of the term “about” in conjunction with a numeral value refers to a value that may be +/- 5% of that numeral. As used herein, the term “substantially free” is intended to mean an amount less than about 5.0 wt.%, less than 3.0 wt.%, 1.0 wt.%; preferably less than about 0.5 wt.%, and more preferably less than about 0.25 wt.% of the composition.

Unless defined otherwise, all technical and scientific terms used herein have the same meanings as commonly understood by one of ordinary skill in the art to which this invention belongs. All patents, patent applications, publications, and other references cited or referred to herein are incorporated by reference in their entireties for all purposes. In the event of a conflict in a definition in the present disclosure and that of a cited reference, the present disclosure controls.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing (if applicable) under discussion. These relative terms are for convenience of description only and, unless specified otherwise, do not require that the apparatus be constructed or operated in a particular orientation.

As used herein, terms such as “attached,” “affixed,” “connected,” “coupled,” “interconnected,” and the like refer to a relationship wherein structures are secured or attached to one another either directly or indirectly through intervening structures, as well as both movable or rigid attachments or relationships, unless expressly described otherwise. Accordingly, the disclosure is not limited to such exemplary embodiments illustrating certain combinations of features that may exist alone or in combination with other features.

The present disclosure is directed towards a surface coating composition and building panels comprising such coating composition. The coating composition is useful to provide beneficial structural and functional properties. In certain aspects, such composition imparts durability and fire resistance properties.

In certain embodiments, the present invention is a coating composition comprising silicate present in an amount from about 65 to about 85 wet wt.%; hectorite clay present in an amount from about 0.15 to about 0.5 wet wt.%; silica present in an amount from about 1 to about 3 wet wt.%; and polysorbate present in an amount from about 0.5 to about 10 wet wt.%. In further embodiments, the invention is a building panel comprising a first major surface opposite a second major surface and a side surface extending there-between, the building panel further comprising a coating comprising silicate present in an amount from about 65 to about 85 wet wt. %; hectorite clay present in an amount from about 0.15 to about 0.5 wet wt. %; silica present in an amount from about 1 to about 3 wet wt. %; and polysorbate present in an amount from about 0.5 to about 10 wet wt. %.

The present invention makes use of silicate as a component of the coating composition. Various forms of silicate may be used. In certain embodiments, the silicate comprises an alkali metal. In certain embodiments, the alkali metal is selected from sodium or potassium. In certain embodiments, the alkali metal is sodium.

The silicate may be present at various amounts or concentrations. In certain embodiments, the silicate may be present in an amount from about 60.0 wt. % to about 90.0 wt.%, based on the wet weight of the composition. For example, the silicate may be present in an amount of about 60.0 weight %, about 61.5 weight %, about 63.0 weight %, about 65.0 weight %, about 67.5 weight %, about 70.0 weight %, about 72.0 weight %, about 73.0 weight %, about 73.3 weight %, about 74.0 weight %, about 76.5 \.0 weight %, about 78.5 weight %, about 80.0 weight %, about 82.5 weight %, about 85.0 weight %, or about 90.0 weight %, based on the wet weight of the composition. In another example, the silicate may be present in an amount of from about 65.0% to about 85.0%, from about 67.5% to about 80.0%, from about 69.0% to about 78.5%, about 70.0% to about 80.0%, or about 72.0% to about 80.0%, based on the wet weight of the composition. In further embodiments, the silicate is present in an amount of about 60.0% or more, about 64.5% or more, about 66.0% or more, up to about 80.0%, based on the wet weight of the composition. In further embodiments, the silicate is present in an amount of about 60.0% to about 80.0%, about 65.0% to about 83.0%, about 70.0% to about 80.0%, or about 72.0% to about 80.5%, based on the wet weight of the composition.

The present invention makes use of hectorite clay as a component of the composition. In certain embodiments, the hectorite clay is a thixotrope. In certain embodiments, the hectorite clay is a solvent-free, waterborne hectorite clay based powder. Hectorite clay may be commercially obtained (Bentone® DH, Elementis). In certain embodiments, the hectorite clay may be present in an amount from about 0.1 wt.% to about 1.0 wt.%, based on the wet weight of the composition. For example, the hectorite clay may be present in an amount of about 0.1 weight %, about 0.2 weight %, about 0.3 weight %, about 0.4 weight %, about 0.5 weight %, about 0.6 weight %, about 0.7 weight %, about 0.8 weight %, about 0.9 weight %, or about 1.0 weight %, based on the wet weight of the composition. In another example, hectorite clay may be present in an amount of from about 0.1% to about 1.0%, from about 0.1% to about 0.8%, from about 0.2% to about 0.8%, about 0.3% to about 0.7%, about 0.3% to about 0.6%, or from about 0.2% to about 0.3%, based on the wet weight of the composition. In further embodiments, the hectorite clay is present in an amount of about 0.1% or more, about 0.2% or more, about 0.3% or more, up to about 1.0%, based on the wet weight of the composition. In further embodiments, the hectorite clay is present in an amount of about 0.15% to about 0.9%, about 0.15% to about 0.8%, about 0.2% to about 0.7%, or about 0.2% to about 0.6%, based on the wet weight of the composition.

The weight ratio of the silicate to the hectorite clay may vary. In certain embodiments, the weight ratio of the silicate to the hectorite clay is from about 200:1 to about 600:1. In certain embodiments, the weight ratio of the silicate to the hectorite clay is from about 200:1 to about 550:1, from about 220:1 to about 525:1, from about 250:1 to about 450:1, or from about 250:1 to about 400:1. In certain embodiments, the weight ratio of silicate to the hectorite clay is from about 215:1 to about 570:1. In certain embodiments, the weight ratio of silicate to the hectorite clay is from about 217:1 to about 567:1, from about 230:1 to about 520:1, from about 240:1 to about 500:1, or from about 240:1 to about 350:1. In certain embodiments, the weight ratio is determined in a wet, or liquid, composition. In certain embodiments, the weight ratio is determined as a dry composition.

The present invention makes use of silica as a component of the coating composition. One or more sources of silica may be utilized. In certain embodiments, the silica is selected from silica dust, fumed silica, finely divided silica, and mixtures thereof. In certain embodiments, the silica is fumed silica.

The amount or concentration of the silica may vary. The silica may be present in an amount from about 1 to about 6%, based on the wet weight of the composition – including all amounts in between. For example, silica may be present in an amount of about 1 wt.%, about 1.5%, about 2%, about 2.5%, about 3%, about 3.5%, about 4%, about 4.5%, about 5%, about 5.5%, or about 6%, based on the wet weight of the composition. In another example, silica is present in an amount from about 1 to about 5%, from about 1 to about 4%, from about 1 to about 3%, from about 2.5 to about 5%, or from about 1.5 to about 4.5%, based on the wet weight of the composition. In further embodiments, silica is present in an amount from about 1 to about 5.5%, from about 1.0 to about 4.5%, or from about 1.0 to about 3.5%, based on the wet weight of the composition.

The present invention makes use of polysorbate as a component of the coating composition. Polyoxyethylene sorbitan esters are synthesized by the addition, via polymerization, of ethylene oxide to sorbitan fatty acid esters. These nonionic hydrophilic emulsifiers are widely known as polysorbates, e.g., polysorbate 20 (tween 20), 60 (tween 60), and 80 (tween 80). Polysorbate 20, 60, and 80 utilize lauric, stearate, and oleate, respectively, for the fatty acid portion of the molecule. In certain embodiments, the polysorbate is selected from the group consisting of polysorbate 20 (polyoxyethylene sorbitan monolaurate, Tween 20), polysorbate 40 (polyoxyethylene sorbitan monopalmitate, Tween 40), polysorbate 60 (polyoxyethylene sorbitan monostearate, Tween 60), polysorbate 80 (polyoxyethylene sorbitan oleate, Tween 80), and mixtures thereof.

The amount or concentration of polysorbate may vary. The polysorbate may be present in an amount from about 0.5 to about 10%, based on the wet weight of the composition -including all amounts in between. For example, polysorbate may be present in an amount of about 0.5%, about 1.0%, about 1.5%, about 2%, about 2.5%, about 3%, about 3.5%, about 4%, about 4.5%, about 5%, about 5.5%, about 6%, about 6.5%, about 7.0%, about 7.5%, about 8.0%, about 8.5%, about 9.0%, about 9.5%, or about 10.0%, based on the wet weight of the composition. In another example, polysorbate is present in an amount from about 0.5 to about 5%, from about 0.7 to about 4%, from about 1 to about 3%, from about 2.5 to about %, or from about 1.5 to about 4.5%, based on the wet weight of the composition. In further embodiments, polysorbate is present in an amount from about 0.2 to about 5.5%, from about 0.2 to about 5.0%, from about 0.5 to about 5.5%, from about 0.5 to about 5.0%, from about 0.5 to about 4.0%, or from about 0.5 to about 2.5%, based on the wet weight of the composition.

The present invention may make use of Al(OH)₃ as a component of the composition. The amount or concentration of the Al(OH)₃ may vary. The Al(OH)₃ may be present in an amount from about 0.5 to about 3.5 wet wt.% – including all amounts in between. For example, Al(OH)₃ may be present in an amount of about 0.5 wet wt.%, about 0.75 wet wt. %, about 1.0 wet wt. %, about 1.25 wet wt. %, about 1.5 wet wt. %, about 1.75 wet wt. %, about 2.0 wet wt. %, about 2.25 wet wt. %, about 2.5 wet wt.%, about 2.75 wet wt. %, about 3.0 wet wt. %, about 3.25 wet wt. %, or about 3.5 wet wt. %. In another example, Al(OH)₃ may be present in an amount from about 0.5 to about 3.0 wet wt.%, from about 0.5 to about 2.75 wet wt. %, from about 0.5 to about 2.5 wet wt. %, from about 0.75 to about 2.25 wet wt. %, from about 1.0 to about 2.0 wet wt. %, or from about 1.0 to about 3.0 wet wt.

The present invention may make use of one or more EO/PO alcohols as a component of the composition. Suitable EO/PO alcohols include, but are not limited to, EO/PO block copolymers commercially available as, e.g., ANTAROX 3181, ANTAROX LA EP 16 and ANTAROX BL 225. The amount or concentration of the one or more EO/PO alcohols may vary. The one or more EO/PO alcohols may be present in an amount from about 0.1 to about 1.5 wet wt.% - including all amounts in between. For example, the one or more EO/PO alcohols may be present in an amount of about 0.1 wet wt. %, about 0.25 wet wt. %, about 0.5 wet wt. %, about 0.75 wet wt. %, about 1.0 wet wt. %, about 1.25 wet wt. %, or about 1.5 wet wt. %. In another example, the one or more EO/PO alcohols may be present in an amount from about 0.1 to about 1.25 wet wt. %, from about 0.3 to about 1.25 wet wt. %, from about 0.1 to about 1.0 wet wt. %, or from about 0.1 to about 0.8 wet wt.

The present invention may make use of one or more defoamers. “Defoamers” herein refer to chemical additives that reduce and hinder the formation of foam. Defoamers may be silicone-based defoamers, mineral oil-based defoamers, ethylene oxide/propylene oxide-based defoamers, alkyl polyacrylates and mixtures thereof. Suitable commercially available defoamers may include, for example, TEGO Airex 902 W and TEGO Foamex 1488 polyether siloxane copolymer emulsions both available from TEGO, BYK-024 silicone deformer available from BYK, and mixtures thereof. In certain embodiments, the defoamer is a polyether-siloxane copolymer emulsion.

The amount or concentration of the one or more defoamers may vary. The one or more defoamers may be present in an amount from about 0.01 to about 1.0 wet wt. % - including all amounts in between. For example, the one or more defoamers may be present in an amount of about 0.01 wet wt. %, about 0.025 wet wt. %, about 0.05 wet wt. %, about 0.075 wet wt.%, about 0.1 wet wt .%, about 0.25 wet wt.%, about 0.5 wet wt. %, about 0.75 wet wt. %, or about 1.0 wet wt. %. In another example, the one or more defoamers may be present in an amount from about 0.01 to about 0.1 wet wt. %, from about 0.01 to about 0.05 wet wt. %, from about 0.02 to about 0.1 wet wt. %, or from about 0.02 to about 0.08 wet wt.

The present invention may make use of a sodium polyacrylate ionic surfactant as a component of the composition. Suitable sodium polyacrylate ionic surfactant include, but are not limited to, sodium polyacrylate ionic surfactant commercially available as, e.g., Nopcote 63900. The amount or concentration of the sodium polyacrylate ionic surfactant may vary. The sodium polyacrylate ionic surfactant may be present in an amount from about 0.005 to about 0.8 wet wt.% - including all amounts in between. For example, the sodium polyacrylate ionic surfactant may be present in an amount of about 0.005 wet wt. %, about 0.008 wet wt. %, about 0.01 wet wt. %, about 0.015 wet wt. %, about 0.02 wet wt. %, about 0.03 wet wt. %, about 0.05 wet wt. %, about 0.1 wet wt. %, about 0.3 wet wt. %, about 0.5 wet wt. %, or about 0.75 wet wt. %. In another example, the sodium polyacrylate ionic surfactant may be present in an amount from about 0.005 to about 0.075 wet wt. %, from about 0.01 to about 0.075 wet wt. %, from about 0.01 to about 0.05 wet wt. %, or from about 0.005 to about 0.05 wet wt.

The weight ratio of the EO/PO alcohol to the sodium polyacrylate ionic surfactant may vary. In certain embodiments, the weight ratio of the EO/PO alcohol to the sodium polyacrylate ionic surfactant is from about 1:1 to about 350:1. In certain embodiments, the weight ratio of the EO/PO alcohol to the sodium polyacrylate ionic surfactant is from about 1:1 to about 300:1, from about 1:1 to about 250:1, from about 10:1 to about 200:1, from about 30:1 to about 150:1, or from about 40:1 to about 100:1. In certain embodiments, the weight ratio of the EO/PO alcohol to the sodium polyacrylate ionic surfactant is from about 40:1 to about 60:1. In certain embodiments, the weight ratio of the EO/PO alcohol to the sodium polyacrylate ionic surfactant is from about 1:1 to about 100:1, from about 120:1 to about 400:1, from about 50:1 to about 500:1, or from about 20:1 to about 200:1. In certain embodiments, the weight ratio is determined in a wet, or liquid, composition. In certain embodiments, the weight ratio is determined as a dry composition.

The present invention may make use of one or more pigments as a component of the composition. Pigments known in the art may be used. In certain embodiments, the pigment has a color selected from white, yellow, brown, black, grey, or a combination thereof. The amount or concentration of the one or more pigment may vary. The one or more pigment may be present in an amount from about 0.01 to about 1.0 wet wt. % - including all amounts in between. For example, pigment may be present in an amount of about 0.01 wet wt. %, about 0.02 wet wt. %, about 0.03 wet wt. %, about 0.04 wet wt. %, about 0.05 wet wt. %, about 0.06 wet wt. %, about 0.07 wet wt. %, about 0.08 wet wt. %, about 0.09 wet wt. %, about 0.1 wet wt. %, about 0.2 wet wt. %, about 0.25 wet wt. %, about 0.3 wet wt. %, about 0.4 wet wt. %, about 0.5 wet wt. %, about 0.6 wet wt. %, about 0.7 wet wt. %, about 0.8 wet wt. %, about 0.9 wet wt. %, or about 1.0 wet wt. %. In another example, pigment may be present in an amount from about 0.05 to about 1.0 wet wt. %, from about 0.05 to about 0.7 wet wt. %, from about 0.01 to about 0.5 wet wt. %, from about 0.05 to about 0.8 wet wt. %, from about 0.1 to about 0.7 wet wt. %, from about 0.2 to about 0.7 wet wt. %, from about 0.2 to about 4.5 wet wt. %, or from about 0.05 to about 0.5 wet wt.

Although the coating composition provides superior fire resistance, in certain embodiments, the building material may comprise one or more fire retardants. In certain embodiments, the fire retardant is selected from magnesium oxide, magnesium sulfate, calcium carbonate, ammonium polyphosphate, or a combination thereof. The one or more fire retardants may be present at various amounts or concentrations. In certain embodiments, the one or more fire retardants are present in an amount from about 50 wt. % to about 70 wt. %. In certain embodiments, magnesium oxide may be present in an amount from about 10 to about 25 wt. %. In certain embodiments, magnesium sulfate may be present in an amount from about 5 to about 10 wt. %. In certain embodiments, calcium carbonate may be present in an amount from about 5 to about 10 wt. %.

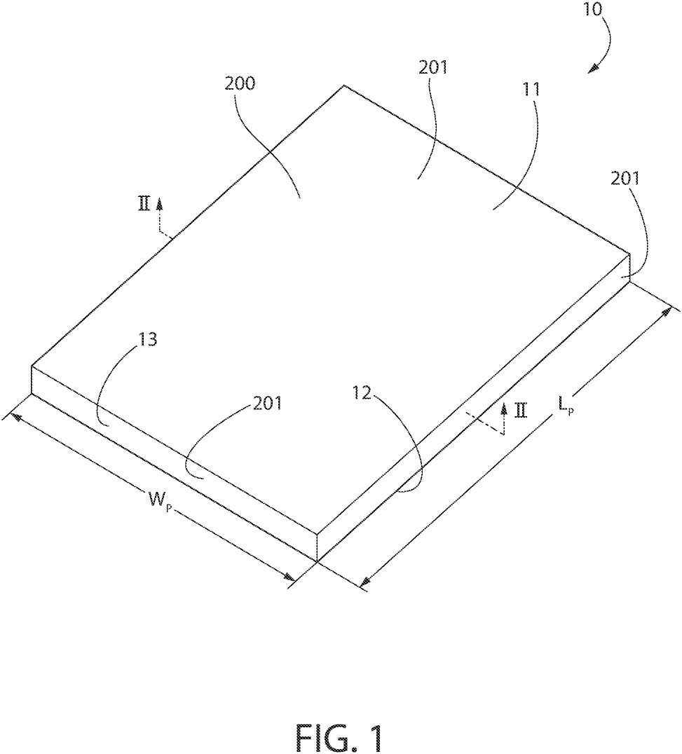

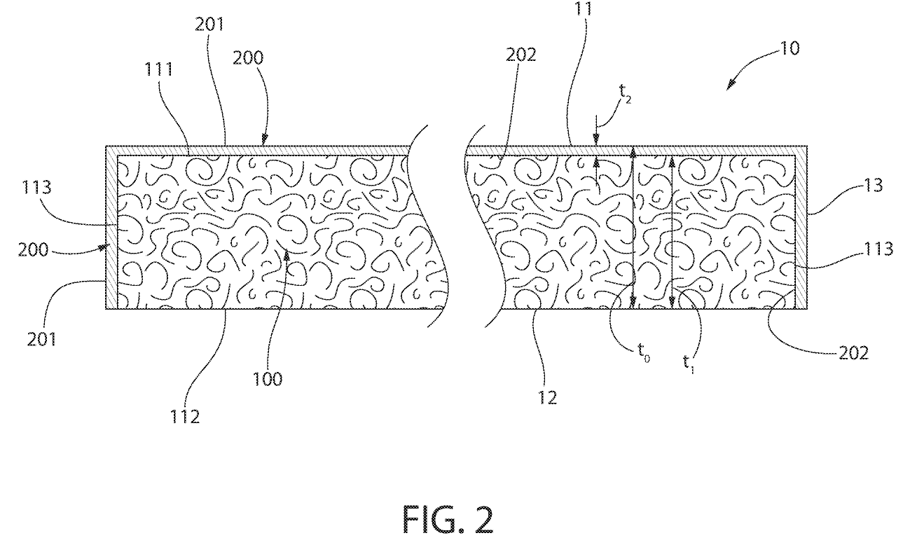

Referring to FIGS. 1 and 2, according to one embodiment, the building panel 10 comprises a first major surface 11 opposite a second major surface 12 and a side surface 13 extending therebetween. The building panel 10 may have a body thickness t₁ that as measured by the distance between the first major surface 11 to the second major surface 12. In this depiction, the building panel 10 has a rectangular shape having a length Lₚ and a width Wₚ.

The building panel 10 comprises a body 100, or substrate which is in contact with a coating 200. The body 100 has an upper side 111 opposite a lower side 112 and side surfaces 113 therebetween. According to the embodiment shown in FIG. 2, the coating 200 surrounds the first major surface 11 and side surface 13 of the body 100. In other embodiments, the coating 200 may be in contact with only the first major surface 11, the second major surface 12, the side surface 13, or a combination thereof.

The building panel 10 may be utilized in various aspects. In certain embodiments, the building panel 10 is a wall panel. In certain embodiments, the building panel 10 is a ceiling panel. In certain embodiments, the building panel 10 is used as both a ceiling panel and a wall panel. In certain embodiments, the building panel 10 is used for indoor applications. In other embodiments, the building panel 10 is utilized for outdoor applications. In certain embodiments, the building panel 10 is comprised of stacked planks. In certain embodiments, the stacked planks includes two, three, or four stacked planks.

The building panel may have various shapes and sizes. In certain embodiments, the building panel can have any desired shape. In certain embodiments, the building panel shape may include polygons, round shapes, and irregular shapes. For example, the shape may be a triangle, square, rectangle, pentagon, hexagon, or any other polygon. For particular installations, other non-regular shapes may be required to, for example, fit around columns or other abnormalities in the ceiling plan. As further non-limiting examples, shapes having nominal angles can also be used such as, for example, a parallelogram shaped building panel, or a trapezoid shaped building panel. In certain embodiments, the building panel has a rectangular shape. In certain embodiments, the building panel has a rectangular shape and contains about a 45° incline from the bottom major surface to the top major surface. In such embodiments, the perimeter of the first major surface is greater than the perimeter of the second major surface.

The size of the building panel may vary. In certain embodiments, the length of the building panel may be from about 900 to about 1300 mm. In certain embodiments, the width of the building panel may be from about 100 to about 200 mm. In certain embodiments, the distance between the first major surface and the second major surface is from about 2 to about 5 mm. In certain embodiments, the distance between the first major surface and the second major surface is about 2 to about 4 mm.

The coating 200 comprises a first side 201 opposite a second side 202. The coating 200 may have a thickness t₂ as measured from the first side 201 to the second side 202. The building panel 10 may have a total thickness t₀ that as determined, according to the embodiment in FIG. 2, by the distance between the first major surface 11 and the second major surface 12 and additionally includes the coating thickness t₂. In another embodiment, if coating is also present on the second major surface 12, then total thickness t₀ is determined by the distance from first major surface 11 to the second major surface 12 in addition to the coating thickness t₂ on each surface.

The building panel 10 may be used as any surface that is desirable. For example, the building panel 10 may be a wall or a ceiling. The body 100 may be made from any appropriate building material. In some embodiments, the body 100 is made from, or comprises, cellulose (such as wood), drywall, or the like. In some embodiments, the body 100 is made from, or comprises, siding, stucco, concrete, brick, or wood. Thus, the body 100 may be formed of a variety of different materials or compositions, including without limitation wood, metal, brick, plastic, fabric, fibrous sheet, glass, ceramic, concrete, plastic film/sheet, paper, medium density fiberboard, fiberglass, mineral fiber sheet, drywall, or the like. In certain embodiments, the body 100 may have a flat/planar shape. In other embodiments, the body 100 may be curved. Furthermore, the body 100 may be horizontal (such as when the substrate is a floor or a ceiling), vertical (such as when the substrate is a wall), or oriented at an angle. In various embodiments, the exposed outer surface of the body 100 may be a smooth surface, a textured surface, or the like.

An important characteristic for building materials is the burning performance. ASTM E84-20 provides methods to determine the relative burning behavior of the material. In particular, ASTM E84-20 provides methods for determining the Flame Spread Index (FSI) which characterizes how far flames generated on the test material spread. The FSI is measured from 0 (indicating no flames) to 200 (which indicates spreading flames). ASTM E84-20 also provides methods for determining the Smoke Developed Index (SDI) which states how much smoke is generated. SDI is measured on a scale of 0 to 450, which correlates to no smoke generated (value of 0) to thick, heavy smoke (value of 450). Obtained FSI and SDI values are then compiled and applied to a three-tiered class system: Class A, Class B, and Class C, with Class A rated materials producing minimal to no flames or smoke, while Class C materials producing the most flames or smoke. In order to qualify as an E84 Class A fire rating, a flame spread index (FSI) of 25 or less and smoke developed index at 450 or less must be exhibited. In certain embodiments, the building panel has a flame spread index (FSI) of about 0 to about 10, as determined by ASTM E84-20. In certain embodiments, the building panel has a flame spread index (FSI) of about 10 as determined by ASTM E84-20. In certain embodiments, the building panel has a flame spread index (FSI) of about 0 as determined by ASTM E84-20. In certain embodiments, the building panel has a smoke developed index (SDI) of about 5 or less as determined by ASTM E84-20.

The inventive coating composition has inherent beneficial characteristics. In certain embodiments, such beneficial characteristic includes functional characteristics. Therefore, in certain embodiments, the invention includes a method for improving the durability of a building panel, the method comprising coating the building panel with a composition as described herein. In other embodiments, the beneficial characteristic includes fire resistance. As such, in certain embodiments, the invention includes a method for improving fire resistance to a building panel, the method comprising coating the building panel with a composition as described herein. In certain embodiments, the invention includes a method for protecting a building panel, comprising coating the building panel with a coating composition as described herein. In certain embodiments, the building panel is a wall or ceiling panel. In certain embodiments, the invention includes a method for

### EXAMPLES

The examples and other implementations described herein are exemplary and not intended to be limiting in describing the full scope of compositions and methods of this disclosure. Equivalent changes, modifications and variations of specific implementations, materials, compositions, and methods may be made within the scope of the present disclosure, with substantially similar results.

Example 1: Coatings were formed by mixing components in approximate quantities as described in Table 1. After mixing, the coatings were sprayed onto a building panel substrate and dried at room temperature.

Table 1

Example 1 coating composition

| Chemicals | Wet Weight % |
|---|---|
| Potassium silicate | 72.851% |
| 3% Hectorite clay solution | 8.287% |
| Fumed Silica | 1.891% |
| Polyether- siloxane copolymer emulsion | 0.040% (0.01-0.08) |
| Sodium polyacrylate ionic surfactant | 0.010% (0.005-0.1) |
| Al(OH)₃ | 1.535% |
| Pigment | 0.0-0.2% |
| EO/PO Alcohol | 0.495% |
| H₂O | q.s. |
| Total | 100% |

Compositions as described in Table 1 formed hard and brittle coatings. Within 24 hours of coating, the compositions showed visible cracking. Furthermore, since wood may expand or contract based upon surrounding temperature and humidity, use of such compositions have poor applicability in real world use.

Example 2: To the compositions as described in Table 1 was added various test components. Coatings were formed by mixing between about 0.5% to about 10.0% wet wt. of test component as described in Table 2 with the compositions described in Table 1. After mixing, the coatings were sprayed onto a wood substrate and air-dried. Average results are reported in Table 2.

Table 2

Component effect testing

| | |
|---|---|
| Component | Results |
| Glycerin | Started to crack in few weeks. The 30-30 test FSR is high with 3% glycerin |
| Polysorbate 20 | Minimal cracks observed. |
| Polysorbate 80 | Slight solubility. |
| PEO/PPO containing poloxamer | Start to crack in about a week. |
| Polysorbate 80 | Start to crack in about a week, poor compatibility for composition as precipitation was observed. |
| Alkaline colloidal silica (40% solids) | Start to crack in about a week. |
| Alkaline, aqueous colloidal silica | Start to crack in about a week. |
| Cellulose fiber | Start to crack in about a week. |
| Microfibrillated | Start to crack in about a week. |
| cellulose | |
| Polyoxy stearyl ether | Solidifies. |
| Polyoxyethylene (20) oleyl ether | Solidifies. |
| Polyether humectant | Slight solubility. |

Surprisingly and unexpectedly, coatings comprising polysorbate 20 showed superior resistance to cracking and were also chemically compatible with the compositions as described in Table 1.

Example 3: Compositions as described in Table 1 and further comprising either glycerin or polysorbate 20 were tested for fire preventive qualities.

Table 3

Fire performance characterization.

| | | |
|---|---|---|
| Performance Quality | Glycerol | Polysorbate 20 |
| ASTM E84 Fire Rating | B | A |

As shown in Table 3, compositions as described in Table 1 and further comprising glycerin provided for a class B test results under ASTM E84 guidelines. Surprisingly, coatings compositions as described in Table 1 and further comprising polysorbate 20 provided for superior fire safety performance, exemplified by the ASTM E84 class A rating. To qualify as a class A under ASTM guidelines, a material must have a flame spread index (FSI) of 25 or below and also provide a smoke developed index of 50 or lower.

As such, coatings of the invention are improved coatings which are chemically compatible, reduce cracking, and provide for superior fire preventative qualities. Such compositions are useful for commercial applications.

While the present invention has been described with reference to several embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention is to be determined from the claims appended hereto. Further, it will be apparent to those of skill in the art that numerous changes may be made in such details without departing from the spirit and the principles of the invention.

1. A building panel comprising a first major surface opposite a second major surface and a side surface extending there-between, the building panel further comprising a coating comprising:
silicate present in an amount from about 65 to about 85 wet wt. %;
hectorite clay present in an amount from about 0.15 to about 0.5 wet wt. %;
silica present in an amount from about 1 to about 3 wet wt. %; and
polysorbate present in an amount from about 0.5 to about 10 wet wt. %.

2. The building panel of claim 1, wherein the silicate comprises an alkali metal.

3. The building panel of claim 2, wherein the alkali metal is selected from sodium or potassium.

4-5. (canceled)

6. The building panel of claim 1, wherein the wet weight ratio of the silicate to the hectorite clay is from about 217:1 to about 567:1.

7-10. (canceled)

11. The building panel of claim 1, wherein the coating further comprises Al(OH)₃; wherein the Al(OH)₃ is present in an amount from about 0.5 to about 3.5 wet wt. %.

12. (canceled)

13. The building panel of claim 1, wherein the coating further comprises EO/PO alcohol, wherein the EO/PO alcohol is present in an amount from about 0.1 to about 1.5 wet wt. %.

14-17. (canceled)

18. The building panel of claim 1, wherein the coating further comprises a polyether-siloxane copolymer emulsion; wherein the polyether-siloxane copolymer emulsion is present in an amount from about 0.01 to about 0.1 wet wt. %.

19. (canceled)

20. The building panel of claim 1, wherein the coating further comprises a sodium polyacrylate ionic surfactant; wherein the sodium polyacrylate ionic surfactant is present in an amount from about 0.005 to about 0.075 wet wt. %.

21-24. (canceled)

25. A coating composition comprising:
silicate present in an amount from about 65 to about 85 wet wt. %;
hectorite clay present in an amount from about 0.15 to about 0.5 wet wt. %;
silica present in an amount from about 1 to about 3 wet wt. %; and
polysorbate present in an amount from about 0.5 to about 10 wet wt. %.

26. The coating composition of claim 25, wherein the silicate comprises an alkali metal.

27. The coating composition of claim 26, wherein the alkali metal is selected from sodium or potassium.

28. The coating composition of claim 25, wherein the silicate is present in an amount from about 70 to about 80 wet wt. %.

29. The coating composition of claim 25, wherein the hectorite clay is present in an amount from about 0.2 to about 0.4 wet wt. %.

30. The coating composition of claim 25, wherein the wet weight ratio of the silicate to the hectorite clay is from about 217:1 to about 567:1.

31-36. (canceled)

37. The coating composition of claim 25, wherein the coating further comprises EO/PO alcohol; wherein the EO/PO alcohol is present in an amount from about 0.1 to about 1.5 wet wt. %.

38-43. (canceled)

44. The coating composition of claim 25, wherein the coating further comprises a sodium polyacrylate ionic surfactant, wherein the sodium polyacrylate ionic surfactant is present in an amount from about 0.005 to about 0.1 wet wt. %.

45. (canceled)

46. The coating composition of claim 44, wherein the wet weight ratio of the EO/PO alcohol to the sodium polyacrylate ionic surfactant is from about 1:1 to about 300:1.

47. (canceled)

48. A method for protecting a building panel, comprising coating the building panel with a coating composition as described in claim 25.

49. The method of claim 48, wherein the building panel is a wall or ceiling panel.

50. The method of claim 48, wherein the building panel comprises cellulose.

51-53. (canceled)
